(19) United States
(12) Patent Application Publication
(10) Pub. No.: US 2010/0081432 A1
(43) Pub. Date: Apr. 1, 2010

(54) LOCALLY PROVIDING CORE-NETWORK SERVICES

(75) Inventor: Mahbubul Alam, McKinney, TX (US)

Correspondence Address: FISH & RICHARDSON P.C., P.O. BOX 1022, MINNEAPOLIS, MN, 55440-1022, US

(73) Assignee: MAVENIR SYSTEMS, INC., A CORPORATION OF TEXAS, Richardson, TX (US)

(21) Appl. No.: 12/240,127

(22) Filed: Sep. 29, 2008

(51) Int. Cl. H04W 60/00; H04W 4/02

(52) U.S. Cl. 455/432.3; 455/422.1; 455/456.2

(57) ABSTRACT

The present disclosure includes a system and method for locally providing core-network services. In some implementations, a method includes receiving, from a first network device, a request for a service provided by a core network native to a second network device. The service is provided to the first network device independent of the core network.

### TECHNICAL FIELD

This invention relates to communication networks and, more particularly, to locally providing core-network services.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communicate in a radio frequency band licensed and controlled by the government.

### SUMMARY

The present disclosure includes a system and method for locally providing core-network services. In some implementations, a method includes receiving, from a first network device, a request for a service provided by a core network native to a second network device. The service is provided to the first network device independent of the core network.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustration a communication system in accordance with some implementations of the present disclosure;

FIG. 2 is a block diagram of the communication system of FIG. 1 for providing core services independent of an associated core network;

FIGS. 3A and 3B are flow charts illustrating an example method for providing services to a foreign device independent of an associated core network;

FIG. 4 is a flow chart illustrating an example method for providing GSM services to a device independent of the device's associated core network;

### DETAILED DESCRIPTION

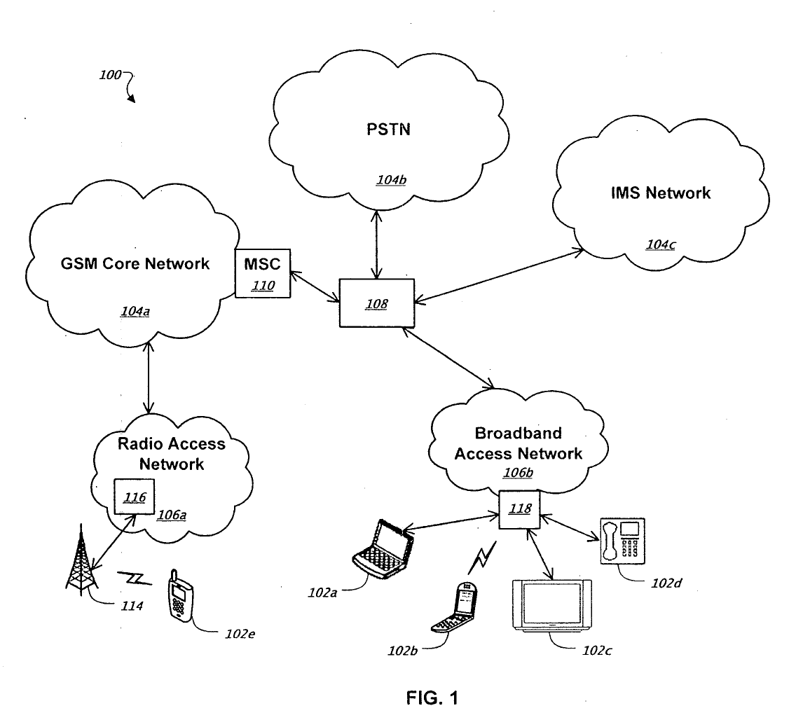

FIG. 1 illustrates a communication system 100 for providing core services independent of an associated core network in accordance with some implementations of the present disclosure. For example, the system 100 may provide services associated with a Global System for Mobile Communication (GSM) core network 104 independent of the GSM core network 104. The system 100 may provide the core services to a native and/or a foreign device 102 independent of the core network 104 associated with the services. In general, a foreign device 102, as used herein, means any communication device 102 that can not directly access or otherwise communicate with one or more core networks 104. Indeed, this foreign device 102 is merely in terms of particular core networks 104—in other words, the foreign device 102 may communicate with and receive services from other core networks 104. In other words, a communication device 102 may be foreign to a core network 104 and, thus, unable to communicate directly with or receive services from that core network 104. In contrast to the foreign device 102, a native device 102 means any communication device 102 that may at least directly access some services from a core network 104. To provide core services independent of the associated core network 104, the system 100 may use authentication information of another device 102, i.e., a master device 102, to authenticate and/or retrieve information identifying services that the master device 102 may access in the core network 102. For example, the foreign communication device 102 may communicate via Session Initiation Protocol (SIP) technology and, thus, be unable to directly access services from the GSM core network 104. By receiving, storing, or otherwise identifying authentication information associated with a GSM device 102, the system 100 may use the GSM authentication information to identify one or more GSM services that the GSM device 102 may access and, in turn, provide one or more of the services to the SIP device 102 independent of the GSM core network 104. In doing so, the system 100 may provide core services (e.g., call waiting, caller identification, mobility management) independent of the associated core network 104 (e.g., the GSM core network 104).

At a high level, system 100 includes communication devices 102, core networks 104, access networks 106, and communication node 108. Each communication device 102 comprises an electronic device operable to receive and transmit network communication with system 100. As used in this disclosure, communication devices 102 are intended to encompass cellular phones, data phones, pagers, portable and stationary computers, smart phones, personal data assistants (PDAs), televisions, electronic gaming devices, one or more processors within these or other devices, or any other suitable processing devices capable of communicating information over a wireless or wired link to access networks 106. Generally, the communication devices 102 may transmit voice, video, multimedia, text, web content or any other user/client-specific content. In short, device 102 generates requests, responses or otherwise communicates with core networks 104 via access networks 106. For purposes of example, a computer device 102a, SIP telephone device 102b, television device 102c, and telephone device 102d are shown communicating with broadband access network 106b. A cellular device 102e communicates with radio access network 106a.

In the illustrated implementation, core networks 104 include GSM core network 104a, Public Switched Telephone Network (PSTN) 104b, and IP Multimedia Subsystem (IMS) network 104c. GSM core network 104a typically includes various switching elements and gateways for providing cellular services. GSM core network 104a often provides these services via a number of Radio Access Networks (RANs), such as RAN 106a, and also interfaces the cellular system with other communication systems such as PSTN 104b via mobile switching center (MSC) 110. In accordance with the GSM standard, GSM core network 104a includes a circuit switched (or voice switching) portion for processing voice calls and a packet switched (or data switching) portion for supporting data transfers such as, for example, e-mail messages and web browsing. The circuit switched portion includes MSC 110 that switches or connects telephone calls between RAN 106a and PSTN 104b or another network. The packet-switched portion, also known as General Packet Radio Service (GPRS), includes a Serving GPRS Support Node (SGSN) (not illustrated), similar to MSC 110, for serving and tracking communication devices 102, and a Gateway GPRS Support Node (GGSN) (not illustrated) for establishing connections between packet-switched networks and communication devices 102. The SGSN may also contain subscriber data useful for establishing and handing over call connections. GSM core network 104a may also include a home location register (HLR) for maintaining “permanent” subscriber data and a visitor location register (VLR) (and/or an SGSN) for “temporarily” maintaining subscriber data retrieved from the HLR and up-to-date information on the location of those communications devices 102 using a wireless communications method. In addition, GSM core network 104a may include Authentication, Authorization, and Accounting (AAA) that performs the role of authenticating, authorizing, and accounting for devices 102 operable to access GSM core network 104a.

PSTN 104b comprises a circuit-switched network that provides fixed telephone services. A circuit-switched network provides a dedicated, fixed amount of capacity (a “circuit”) between the two devices for the duration of a transmission session. In general, PSTN 104b may transmit voice, other audio, video, and data signals. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the form of either dial pulses or multi-frequency tones.

IMS network 104c is a network that enables mobile communication technology to access IP based services. The IMS standard was introduced by the 3rd Generation Partnership Project (3GPP) which is the European 3rd generation mobile communication standard. In general, the IMS standard discloses a method of receiving an IP based service through a wireless communication terminal such as those communication devices 102 which are capable of wireless communications, for example wireless telephone 102b. To achieve these goals, IMS network 104c uses Session Initiation Protocol (SIP) and, in some implementations, wireless telephone 102b is operable to use the same protocol when accessing services through broadband access network 106b. Although not illustrated, IMS network 104c may include Call Session Control Function (CSCF), Home Subscriber Server (HSS), Application Server (AS), and other elements. CSCF acts as a proxy and routes SIP messages to IMS network components such as AS. HSS typically functions as a data repository for subscriber profile information, such as a listing of the type of services allowed for a subscriber. AS provides various services for users of IMS network 104c, such as, for example, video conferencing, in which case AS handles the audio and video synchronization and distribution to communication devices 102.

Turning to access networks 106, access networks 106 include RAN 106a and broadband network 106b. RAN 106a provides a radio interface between mobile device 102e and GSM core network 104a which may provide real-time voice, data, and multimedia services (e.g., a call) to mobile device 102e. In general, RAN 106a communicates air frames via radio frequency (RF) links. In particular, RAN 106a converts between air frames to physical link based messages for transmission through GSM core network 104a. RAN 106a may implement, for example, one of the following wireless interface standards during transmission: Advanced Mobile Phone Service (AMPS), GSM standards, Code Division Multiple Access (CDMA), Time Division Multiple Access (TDMA), IS-54 (TDMA), General Packet Radio Service (GPRS), Enhanced Data Rates for Global Evolution (EDGE), or proprietary radio interfaces. Users may subscribe to RAN 106a, for example, to receive cellular telephone service, Global Positioning System (GPS) service, XM radio service, etc.

RAN 106a may include Base Stations (BS) 114 connected to Base Station Controllers (BSC) 116. BS 114 receives and transmits air frames within a geographic region of RAN 106a (i.e. transmitted by a cellular device 102e) and communicates with other mobile devices 102 connected to the GSM core network 104a. Each BSC 116 is associated with one or more BS 114 and controls the associated BS 114. For example, BSC 116 may provide functions such as handover, cell configuration data, control of RF power levels or any other suitable functions for managing radio resource and routing signals to and from BS 114. MSC 110 handles access to BSC 116 and communication node 108, which may appear as a BSC 116 to MSC 110. MSC 110 may be connected to BSC 116 through a standard interface such as the A-interface.

Broadband access network 106b facilitates communication between communication devices 102 and communication node 108. In general, broadband access network 106b communicates IP packets to transfer voice, video, data, and other suitable information between network addresses. In the case of multimedia sessions, broadband access network 106b uses Voice over IP (VoIP) protocols to set up, route, and tear down calls. Communication devices 102 connect to broadband access network 106b through an access point 118. Access point 118 may include one or more local area networks (LANs), metropolitan area networks (MANs), wide area networks (WANs), all or a portion of the global computer network known as the Internet, and/or any other communication system or systems at one or more locations. Users may subscribe to the broadband access network 106b, for example, to receive cable television services, DSL or modem internet access via the PSTN core network 104b, wireless microwave broadband internet access (WiMAX), fiber optic cable internet access (FTTC/H Ethernet), wireless personal access networking (WiFi/Bluetooth), digital mobile telephony access (GSM over IP, UMTS over IP), etc.

In general, communication node 108 can include any software, hardware, and/or firmware operable to provide subscriber services regardless of the core network associated with the requesting device 102. For example, communication node 108 may enable a device 102 to make use of foreign services provided by a core network 104. In this example, communication node 108 may use authentication information associated with a device 102 native to core network 104 in providing the foreign services. For example, the communication node 108 may query a core network 104 for information identifying services associated with authentication information. In response to at least the identify services, the communication node 108 may replicate or otherwise provide those services independent of the core network 104. The authentication information associated with the native device 102 may be locally stored, requested from the native device 102 in response to at least a request for foreign services, and/or provided to communication node 108 using any other suitable process. The authentication information may be associated with subscriber services. For example, the authentication information may be used to remotely provide some foreign services natively provided by core network 104. In some instances, authentication information is provided to the subscriber as an access key for gaining admission to the services and/or technologies provided in a service subscription. The subscription services may be based on any appropriate parameter such as a specific device 102, specific user of a device 102, a device type, and/or any other suitable parameters that may distinguish different services. Services may include, for example, call waiting, caller identification, conference calling, voicemail, and/or others. While illustrated as a node in the network 106b, the node 108 may be an element in the cellular core network 104a such that the communication node 108 provides foreign services to mobile devices 102 through the cellular core network 104. For example, the node 108 may locally provide services from the IMS network 104c such that the devices 102 access the services through the cellular core network 104a.

In some cases, communication node 108 may use authentication information to identify and remotely provide foreign services where the information is owned by the requesting user but using a different device 102 to gain access to the subscription services. For example, a user subscribing to both a cellular service provided by GSM core network 104a and a DSL service provided by IMS network 104c may place a voice call through the laptop computer 102a, utilizing the cellular conference calling subscription service commonly associated with mobile device 102e, by first requesting and authenticating subscriber access to the cellular service subscription via communication node 108. The communication node 108 may then remotely provide the conference calling service independent of the GSM core network 104a. In general, communication node 108 may be an integrated and/or stand alone unit and, in addition, may be part of a rack or system. In some implementations, communication node 108 comprises a system. A system may be a single node, a plurality of nodes, or a portion of one or more nodes. A system may be distributed and may cross network boundaries.

In one aspect of operation, the subscriber may have previously registered the authentication information with the communication node 108, for example during subscription service sign-up. In another aspect of operation, the subscriber may only register contact information for the device 102 which contains the authentication information, for example an IP address, phone number, etc. The subscriber may receive a request from the communication node 108 through the locally subscribed device 102 whenever a foreign device 102 requests the authentication information to access subscription services within the foreign core network 104. Authentication information may alternatively be provided within a device separate from the communication devices 102, for example within a subscriber identity module (SIM), smart card, or any other secure electronic storage media in the possession of the subscriber.

The foreign device 102 may additionally require communications translation to benefit from services provided by the foreign core network 104. If the networking communications protocol(s) used by the foreign device 102 are incompatible with the networking communications protocol(s) understood by the foreign core network 104, communications node 108 may provide communication translation service for foreign device 102. For example, a user's laptop 102a may commonly communicate via the SIP standard for voice communications. To allow the laptop 102a to receive voicemail messages via the user's cellular service voice mailbox subscription service, the communications node 108 may need to translate the GSM messages remotely stored at the communication node 108 to SIP before forwarding them to access point 118.

The services remotely provided by communications node 108 may be transparent to communication devices 102 and/or core networks 104. For example, communication node 108 may appear to be a standard networking router, switch, or other network edge communication device such as MSC 110. It may be capable of communicating in a wide variety of networking protocols, allowing many dissimilar networking components to view it as native equipment.

In one aspect of operation, communication node 108 receives a request for foreign services. For example, SIP device 102d may request call waiting services from GSM network 104a. In response to at least the request, communication node 108 identifies authorization information associated with a communication device 102 native to core network 104 that provides the foreign services. In some implementations, the authorization information associated with the native device 102 may be locally stored at communication node 108. In some implementations, communication node 108 may transmit a request to the native device 102 for the authorization information. Using the identified authorization information, communication node 108 may register the native device 102 with the core network 104. During device registration, the communication node 108 may be provided with a list of subscription services available to the native device 102. The communication node 108 may then use this list of subscription services to provide the requesting device 102 with one or more of the services commonly provided by the foreign network 104 as if the requesting device 102 is a native device 102.

In another aspect of operation, communication node 108 receives a request for native services. In the event that, for example, a SIP device 102d attempts to make use of the movies-on-demand service provided through the IMS core network 104c, the communication node 108 can provide this service independently of the IMS core network 104c. In some implementations, the communication node 108 retrieves and stores subscription service information from core networks 104. The communication node 108 may then be capable of providing the subscription services to communication devices 102 without requiring communication with the core networks 104. Rather than retrieving subscription service information from core networks 104, the communication node 108, in some implementations, may be provided with subscription service updates from each core network 104. These subscription service updates may occur, for example, on an established schedule and/or when modifications have occurred to a user's subscription services.

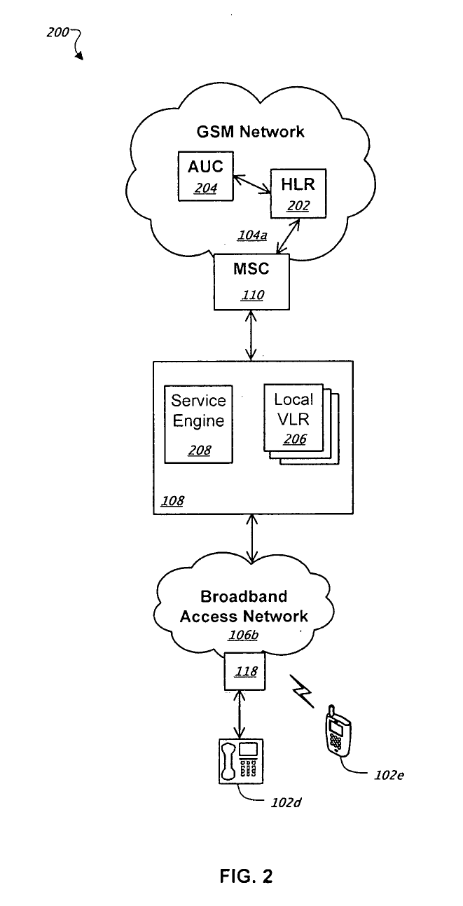

FIG. 2 is a block diagram 200 of communication system 100 for providing subscription services to communication devices 102 independent of a core network 104. For ease of reference, only some of the elements of communication system 100 of FIG. 1 are shown. As discussed above, system 100 may use subscription information associated with a device 102, i.e., a master device 102, for remotely providing foreign services to either the master device 102 or a different device 102. For example, system 100 may use information and functionality provided in a SIM card of a GSM device 102 to determine subscription services available to GSM device 102. The system 100 may then provide any or all of the available GSM subscription services to a SIP phone 102d. System 100 may derive subscription information while authenticating GSM device 102 with GSM core network 104a. During the authentication process with GSM network 104a, GSM subscription information may be relayed from the GSM network 104a to the system 100. System 100 may then provide subscription services to a device 102 independent of core network 104. System 100 may remotely provide these services to a native device 102 and/or a foreign device 102.

While the following description is in terms of core network 104 being the GSM core network 104a and devices 102 being SIP phone 102d and cellular device 102e, the scope of this disclosure contemplates that core network 104 may be any other suitable core network technology and/or devices 102 may be another communication technology both foreign and local to core network 104. Such implementations may use the same, none, or all of the features and functions described with respect to GSM technology and/or SIP technology.

Referring to FIG. 2, system 100 authenticates cellular device 102e with GSM core network 104a by presenting communication node 108 as a base station controller (BSC). For example, system 100 may present communication node 108 as a BSC to GSM core network 104a to perform authentication steps for cellular device 102e. Communication node 108 may then receive service information related to cellular device 102e from GSM core network 104a. The service information may be remotely stored within the communication node 108. The service information may then be used to remotely provide services related to cellular device 102e. These services may be available to either SIP phone 102d or cellular device 102e.

At a high level, GSM core network 104a includes Home Location Register (HLR) 202 and Authentication Center (AUC) 204. The AUC 204 contains authentication data keys (Ki) associated with each International Mobile Subscriber Identity (IMSI). The HLR 202 may access this authentication information for validating subscribers within GSM core network 104a. The HLR 202 contains a “permanent” database of GSM subscriber data, including subscription information. This subscription information is sometimes referred to as the Supplementary Services (SS), a standardized coding of services GSM core network 104a may offer to subscribing device 102. The European Telecommunications Standards Institute (ETSI) and the Third Generation Partnership Project (3GPP) are two standards provided for setting and querying SS parameters. These services may include, but are not limited to, Calling Line Identification Restriction (CLIR), Calling Line Identification Presentation (CLIP), call hold, call waiting, multi-party conferencing, call forwarding, barring outgoing calls, barring incoming calls, and explicit call transfer.

In the illustrated implementation, the communication node 108 includes a Visitor Location Register (VLR) 206 and a service engine 208. The VLR 206 locally stores or otherwise identifies maintains subscriber data and subscription service information retrieved from the HLR 202. For example, the VLR 206 may include up-to-date information on the location of communications devices 102, stored within a Location Area ID (LAI). The VLR 206 also correlates each IMSI record with a Temporary Mobile Subscriber Identity (TMSI) for identification of subscribers associated with a particular Location Area (LA). In some implementations, a subscriber can be uniquely identified via the combination of TMSI and LAI. Whenever a subscriber switches into a new LA, the LAI and TMSI can, in some implementations be updated accordingly within the VLR 206. The LAI and TMSI may be broadcast across system 100, preferably in an encrypted format, while the IMSI remains hidden to ensure its security.

The service engine 208 can include any software, hardware, and/or firmware operable to remote provide subscriber services independent the associated core network 104. For example, the service engine 208 may be capable of providing call waiting, caller identification, and/or call forwarding to a communication device 102. In some implementations, the communication node 108 receives SS codes from MSC 110 when authenticating a native GSM communications device 102 with GSM core network 104a. The communication node 108 may store the SS codes within the local VLR 206. When the native communications device 102 or a foreign communications device 102 associated with native communications device 102 (e.g., owned by the same subscriber) requests a subscription service, the communication node 108 can verify access to the SS code contained within the device's query by looking it up within the local VLR 206. If the user does have a subscription to the service requested, the communication node 108 may provide the service remotely through service engine 208 without requiring additional communication with GSM core network 104a.

In one aspect of operation, cellular phone 102e connects to broadband network 106b via the network access point 118, for example a local internet service provider network. As a local device, the cellular phone 102e requests access to GSM core network 104a. The communication node 108 facilitates authentication with the GSM core network 104a through communications with MSC 110. MSC 110 provides authentication data and subscription service information from HLR 202. Communication node 108 stores these records locally within VLR 206.

Cellular phone 102e further requests use of the CLIR subscription service. This service allows the user to bar the telephone number associated with cellular phone 102e from being provided to another device's caller id. Communication node 108 verifies access to the CLIR SS by referencing the record within local VLR 206. If the cellular phone 102e has access to a CLIR subscription service, the communication node 108 provides this service independent of GSM core network 104a through service engine 208.

In a further aspect of operation, SIP phone 102d, owned by the same user as cellular device 102e, connects to broadband network 106b. As a foreign device, the SIP phone 102d requests access to one or more of the services provided by the GSM core network 104a to cellular device 102e. In some implementations, the SIP phone 102d authenticates itself within IMS core network 104c prior to receiving GSM services. The IMS core network 104c transmits an authentication request to the SIP phone 102d. SIP phone 102d responds with authentication information and achieves authorization within the IMS core network 104c.

Next, communication node 108 intercepts a request from SIP phone 102d for access to the CLIP service provided by the GSM core network 104a for cellular phone 102e. In some implementations, the communication node 108 can authorize the SIP phone 102d to gain access to subscription services associated with cellular phone 102e. In one example, the owner of both devices 102 may have previously authorized, with communication node 108, GSM services for the SIP phone 102d. In another example, communication node 108 may query cellular phone 102e to gain authorization prior to allowing SIP phone 102d access to subscription services associated with cellular phone 102e. Once communication node 108 has authenticated SIP phone 102d with the services associated with cellular phone 102e, communication node 108 may provide one or more subscriber services to SIP phone 102d.

The communication node 108 may be capable of providing the CLIP service requested without contacting the GSM core network 104a. The service engine 208 within communication node 108 may contain functionality for the CLIP feature. In this manner, the communication node 108 may remotely offer the CLIP service to SIP phone 102d. Because this service is commonly associated with the cellular phone 102e which communicates with the GSM core network 104a, the common communications protocol for the CLIP service may differ from the communications protocols native to the SIP phone 102d. In this circumstance, the communication node 108, in some implementations, may provide communications translation for SIP phone 102d.

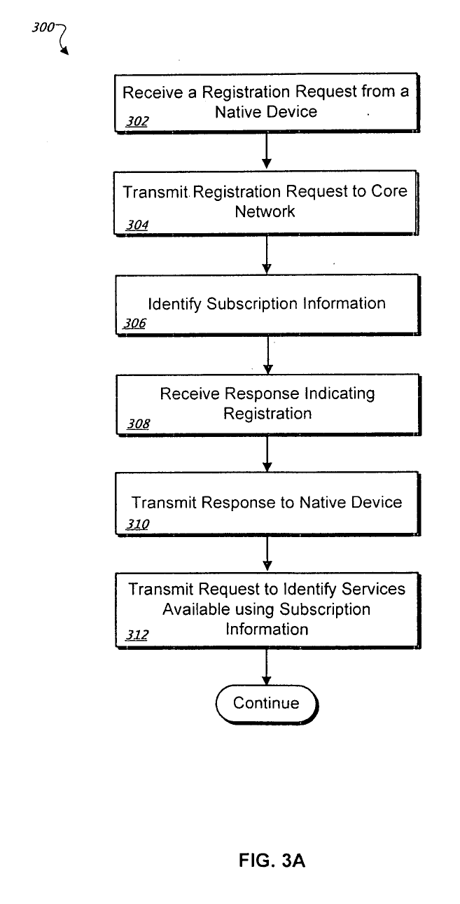

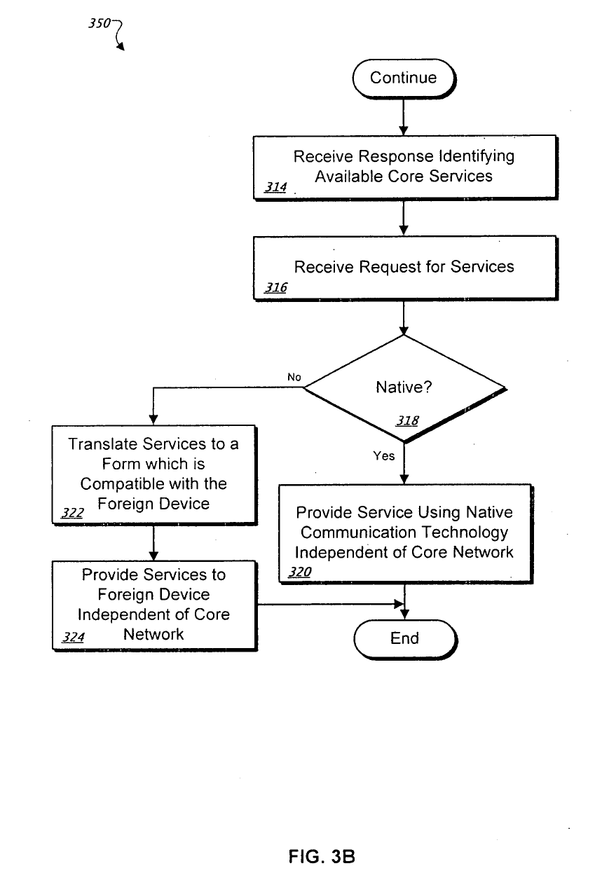

FIGS. 3A and 3B are flow charts illustrating an example method 300 for providing subscription services to a communication device independent of an associated core network. The illustrated method is described with respect to communication system 100 of FIG. 1, but these methods could be used by any other suitable system. Moreover, communication system 100 may use any other suitable techniques for performing these tasks. Thus, many of the steps in this flowchart may take place simultaneously and/or in different order than as shown. Communication system 100 may also use methods with additional steps, fewer steps, and/or different steps, so long as the methods remain appropriate.

Referring to FIG. 3A, method 300 begins at step 302 where the communication node 108 receives a registration request from a native device 102. For example, cellular device 102e may be a native device to GSM core network 104a. Cellular device 102e may view communication node 108, for instance, as a BSC for GSM core network 104a. Upon entering the vicinity of communications node 108, cellular device 102e may broadcast a location update to communication node 108. The communication node 108 then transmits the registration request to the core network 104 associated with native device 102 in step 304. For example, communication node 108 transmits the location update request from cellular device 102e to GSM core network 104a via MSC 110.

At step 306, communication node 108 identifies subscription information associated with device 102. The subscription information may have been forwarded by device 102 within the registration request during step 302. For example, the location update request forwarded by cellular device 102e may contain subscription information, including but not limited to a telephone number, customer identification number, or other identifying data associated with cellular device 102e and/or the user associated with cellular device 102e. In other implementations, the subscription information may have previously been registered with communication node 108. For example, one or more data records within the registration request may identify the subscription record held by communication node 108.

The communication node 108 receives a response from core network 104 indicating the registration status of device 102 at step 308. For example, communication node 108 may receive an updated registration status regarding the present location of the cellular device 102e. The VLR 206 contained within the communication node 108, in this example, represents the present location (e.g., closest access node 116) of cellular device 102e with respect to the GSM core network 104a. The communication node 108 may receive a Temporary Mobile Subscriber Identity (TMSI) associated with the cellular device 102e from the GSM core network 104a. The communication node 108 in turn transmits this response to the native device 102 in step 310. For example, the cellular device 102e may receive the updated TMSI from GSM core network 104a.

At step 312, communication node 108 transmits a request to core network 104 to identify the subscription services available to device 102. The service request contains the subscription information identified within step 306. In one example, the communication node 108 transmits a request to GSM core network 104a on behalf of cellular device 102e to identify its subscription services. This message may be provided to MSC 110 using 3GPP service query codes.

Referring to FIG. 3B, the communication node 108 receives a response from core network 104 identifying the subscription services available to device 102 at step 314. In some implementations, the communication node 108 may store the list of available subscription services within VLR 206, associating the subscription services with the subscription information belonging to device 102. For example, the GSM subscription services associated with cellular device 102e may be stored within VLR 206.

At step 316, communication node 108 receives a request for subscription services associated with core network 104 from device 102. For example, device 102 may request the call hold subscription service available through GSM core network 104a. At decisional step 318, communication node 108 determines whether or not device 102 is native to core network 104. For example, cellular device 102e may request subscription services from its native core network 104, GSM core network 104a. If device 102 is native to core network 104, communication node 108 provides the requested service, at step 320, using the communications technology native to the core network 104 and device 102. Communication node 108 provides this service independent of the core network 104. For example, communication node 108 may provide a service offered by GSM core network 104a using service engine 208 without needing to communicate with GSM core network 104a.

Communication node 108 may instead be requested, at decisional step 318, to provide a subscription service to a device 102 which is foreign to the core network 104. For example, SIP phone 102d may request subscription services from GSM core network 104a, even though SIP phone 102d can be foreign to GSM core network 104a. If device 102 is foreign to core network 104, communication node 108 first translates the service to a communications protocol which is compatible with the foreign device 102 at step 322. For example, communication node 108 may translate the GSM messages commonly used to provide a GSM service into SIP messages before providing a GSM service to SIP phone 102d. Upon translation, at step 324, the communication node 108 provides the requested service to the foreign device 102 independent of the core network 104. For example, the communication node 108 may provide remote access of GSM services through service engine 208 to SIP phone 102d without any communication required between communication node 108 and GSM core network 104a.

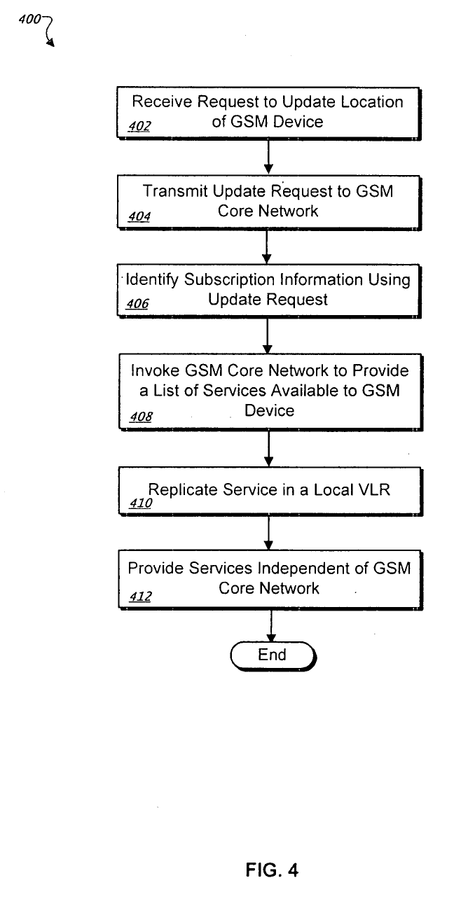

FIG. 4 is a flow chart illustrating an example method 400 for providing GSM services to a device 102 independent of the device's associated core network 104. The illustrated method is described with respect to how communication system 100 relates with the block diagram 200 of FIG. 2, but these methods could be used by any other suitable system. Moreover, communication system 100 may use any other suitable techniques for performing these tasks. Thus, many of the steps in this flowchart may take place simultaneously and/or in different order than as shown. Communication system 100 may also use methods with additional steps, fewer steps, and/or different steps, so long as the methods remain appropriate.

Method 400 begins at step 402 where communication node 108 receives a request to update the location of a GSM device 102. For example, the cellular device 102e may have just entered the range of communication node 108, which may appear as a BSC or MSC. At step 404, communication node 108 transmits a location update request to the GSM core network 104a on behalf of the GSM device 102. In some examples, the communication node 108 may transmit this message using the communication protocol associated with a BSC.

The communication node 108, at step 406, identifies subscription information regarding the GSM device 102 using the update request message. For example, communication node 108 may identify information such as a telephone number and/or other device and/or customer identifier by parsing the location update request sent. The communication node 108 may then query the GSM core network 104a for a list of subscription services available to the GSM device 102 at step 408. For example, the communication node 108 may transmit a query message using the ETSI or 3GPP standards to query MSC 110 regarding the subscription service status for cellular device 102e.

At step 410, communication node 108 locally stores the subscription service information in local VLR 206. For example, once a query response has been obtained from MSC 110, the communication node 108 may generate or modify a subscription service record within local VLR 206 associated with the subscription information related to cellular device 102e. The communication node 108 may then provide subscription services to GSM device 102 independent of GSM core network 104a at step 412. The services may be provided remotely by communication node 108, for example, through localized capability contained within service engine 208.

A number of implementations of the invention have been described. Nevertheless, it will be understood that various modifications may be made without departing from the spirit and scope of the invention.

What is claimed is:

1. A method, comprising:
receiving, from a first network device, a request for a service provided by a core network native to a second network device; and
providing the service to the first network device independent of the core network.

2. The method of claim 1, wherein providing the service comprises:
locally identifying services provided by the core network to a second network, the core network native to the second network device;
determining the requested service matches one of the locally identified services; and
providing the requested service to the first network device in response to at least the match independent of the core network.

3. The method of claim 2, further comprising:
transmitting, to the core network, a request for information identifying services provided to the second network device;
receiving the information identifying services provided by the core network to the first network device; and
locally storing the service information associated with the second network device for locally providing the identified services.

4. The method of claim 2, the second network device comprising a mobile device, the method further comprising:
receiving a request to update a location of the mobile device; and
identifying subscription information based, at least in part, on the update request.

5. The method of claim 3, wherein transmitting, to the remote network device, a request for information identifying services associated with the first network device comprises:
identifying codes associated with the core network for receiving statuses of services associated with the first network device; and
transmitting the status codes to the remote network device.

6. The method of claim 1, wherein the first network device comprises one of a GSM mobile device, a UMTS mobile device, or a UMA mobile device.

7. The method of claim 1, wherein the core network comprises a GSM core network.

8. The method of claim 2, wherein locally identifying services available to the second network device based, at least in part, on the request comprises:
identifying a local VLR table associated with the first network device; and
identifying a status of the requested service in accordance with the local VLR.

9. The method of claim 1, further comprising:
receiving a request to update location of the second network device; and
transmitting the location update to the core network.

10. The method of claim 9, further comprising:
identifying authentication information associated with the second network device; and
receiving information identifying services associated with the second network device that are provided by the core network.

11. A system, comprising:
a receiver configured to receive, from a first network device, a request for a service provided by a core network native to a second network device; and
a service module configured to provide the service to the first network device independent of the core network.

12. The system of claim 11, wherein the service module configured to provide the service comprises the service module configured to:
locally identify services provided by the core network to a second network, the core network native to the second network device;
determine the requested service matches one of the locally identified services; and
provide the requested service to the first network device in response to at least the match independent of the core network.

13. The system of claim 12, further comprising:
an interface configured to transmit, to the core network, a request for information identifying services provided to the second network device and receive the information identifying services provided by the core network to the first network device; and
memory configured to locally store the service information associated with the second network device for locally providing the identified services.

14. The system of claim 12, the second network device comprising a mobile device, further comprising:
the receiver further configured to receive a request to update a location of the mobile device; and
the service module further configured to identify subscription information based, at least in part, on the update request.

15. The system of claim 13, wherein the interface configured to transmit, to the remote network device, a request comprises the interface configured to:
identify codes associated with the core network for receiving statuses of services associated with the first network device; and
transmit the status codes to the remote network device.

16. The system of claim 11, wherein the first network device comprises one of a GSM mobile device, a UMTS mobile device, or a UMA mobile device.

17. The system of claim 11, wherein the core network comprises a GSM core network.

18. The system of claim 12, wherein the service module configured to locally identify services comprises the service module configured to:
identify a local VLR table associated with the first network device; and
identify a status of the request service in accordance with the local VLR.

19. The system of claim 1, further comprising:
the receiver further configured to receive a request to update location of the second network device; and
an interface configured to transmit the location update to the core network.

20. The system of claim 19, further comprising:
the receiver further configured to identify authentication information associated with the second network device; and
the interface further configured to receive information identifying services associated with the second network device that are provided by the core network.
